(19) United States
(12) Patent Application Publication
(10) Pub. No.: US 2025/0050755 A1
(43) Pub. Date: Feb. 13, 2025

(54) Charging Harness Mounting Device

(71) Applicants: Timothy Byland, Plymouth, MN (US); Jeremy Jevne, Ham Lake, MN (US)

(72) Inventors: Timothy Byland, Plymouth, MN (US); Jeremy Jevne, Ham Lake, MN (US)

(21) Appl. No.: 18/607,996

(22) Filed: Mar. 18, 2024

Related U.S. Application Data
(60) Provisional application No. 63/518,351, filed on Aug. 9, 2023.

(51) Int. Cl. B60L 53/16

(52) U.S. Cl. CPC B60L 53/16

(57) ABSTRACT

A charging harness mounting device is provided. The device is comprised of a mounting structure that receives a charging harness. The structure can then be secured to or around the frame of an ATV, dirt bike, UTV, etc., in order to secure the charging harness in a constant location and position.

### CROSS-REFERENCE TO RELATED APPLICATION

The present application claims priority to, and the benefit of, U.S. Provisional Application No. 63/518,351, which was filed on Aug. 9, 2023, and is incorporated herein by reference in its entirety.

### FIELD OF THE INVENTION

The present invention relates generally to the field of charging harness mounts. More specifically, the present invention relates to a charging harness mounting device that provides a mount for a charging harness on an ATV, UTV, etc. Accordingly, the present disclosure makes specific reference thereto. Nonetheless, it is to be appreciated that aspects of the present invention are also equally applicable to other like applications, devices, and methods of manufacture.

### BACKGROUND

Charging harnesses found on ATVs, dirt bikes, UTVs, and similar off-road vehicles, are typically concealed and not conveniently accessible to the operator for battery charging. This lack of accessibility not only makes routine charging difficult but also raises safety concerns. For instance, an unrestrained charging harness, which is not securely anchored, may inadvertently encounter hot surfaces within the vehicle's mechanical structure. Such contact can result in significant damage to the harness, potentially compromising its functionality and, in severe cases, rendering it completely inoperable. Furthermore, when an unrestrained charging harness sways or moves freely, there's a high likelihood of it coming into contact with the vehicle's painted surfaces. This unintended contact can lead to scratches, chips, or other forms of damage to the finish, compromising the aesthetic appeal and possibly the resale value of the vehicle.

Therefore, there exists a long-felt need in the art for a device for securing a charging harness. There also exists a long-felt need in the art for a charging harness mounting device. More specifically, there exists a long-felt need in the art for a charging harness mounting device that allows a charging harness to be secured to the frame of an ATV, dirt bike, UTV, or other vehicle.

The subject matter disclosed and claimed herein, in one embodiment thereof, comprises a charging harness mounting device. The device is comprised of a mounting structure that receives a charging harness. The structure can then be secured to or around the frame of an ATV, dirt bike, UTV, etc., in order to secure the charging harness in a constant location and position.

In this manner, the charging harness mounting device of the present invention accomplishes all the foregoing objectives and provides a device for securing a charging harness. More specifically, the device that allows a charging harness to be secured to the frame of an ATV, dirt bike, UTV, or other vehicle. In this manner, the harness and/or frame cannot be damaged and can be easily accessed in a constant location when needed.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a charging harness mounting device. The device is designed to receive at least one charging harness, wherein the device secures the harness to at least one frame 16 (or other portion) of a vehicle such as, but not limited to, a motorcycle, a dirt bike, an ATV, a UTV, etc.

The device is comprised of a body that preferably forms an angle between 0 and 180 degrees. The body is comprised of a first end comprised of at least one (but preferably two) forks. The body is comprised of at least one opening between the forks such that the forks can be placed around either side of a flat portion of the frame of a vehicle, wherein at least one fastener, can be placed through the forks and into the frame to secure the device to the frame. This allows the device to remain secured to the frame during use.

In one embodiment, the first end is comprised of at least one clamp that opens/closes relative to the body around at least one hinge. In this manner, at least one opening of the clamp can be secured around at least one frame of a vehicle the device is being used on. To secure the clamp around the frame, the clamp may be comprised of at least one locking mechanism of any type known in the art that inhibits movement of the clamp.

The second end of the body is comprised of at least one channel configured to receive the body of at least one charging harness. This allows the harness to be secured within the body such that the device prevents movement of the harness. In one embodiment, the body is comprised of at least one set screw opening. The opening may be threaded or non-threaded and allows at least one set screw (which may be threaded) to be inserted through the body to secure the charging harness in the body.

The device is also comprised of a first method of using the device. First, a device is provided comprised of a body with a first end comprised of at least two forks, and a channel. Then, the forks can be placed on the surface of a vehicle such that a removable fastener may be loosened/removed and positioned in an opening between the forks and fastened to the vehicle such that the body is secured to the vehicle's surface. Then, at least one charging harness can be placed into the channel of the body such that the harness is secured in a desired position.

The device is also comprised of a second method of using the device. First, a device is provided comprised of a body with a first end comprised of at least one clamp, and a channel. Then, the clamp can be opened and placed around a frame member of a vehicle such that the frame is positioned within the opening of the clamp. Next, the clamp can be closed around the frame and secured in a locked position via at least one locking mechanism. Then, at least one charging harness can be placed into the channel of the body such that the harness is secured in a desired position.

Accordingly, the charging harness mounting device of the present invention is particularly advantageous as it provides a device for securing a charging harness. More specifically, the device that allows a charging harness to be secured to the frame of an ATV, dirt bike, UTV, or other vehicle. In this manner, the harness and/or frame cannot be damaged and can be easily accessed in a constant location when needed. In this manner, the charging harness mounting device overcomes the limitations of existing charging harnesses known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a charging harness mounting device of the present invention with a fastener placed between the forks in accordance with the disclosed architecture;

FIG. 2 illustrates a side view of one potential embodiment of a charging harness mounting device of the present invention in accordance with the disclosed architecture;

FIG. 3 illustrates a rear perspective view of one potential embodiment of a charging harness mounting device of the present invention with a channel in accordance with the disclosed architecture;

FIG. 4 illustrates a rear perspective view of one potential embodiment of a charging harness mounting device of the present invention with an opening in accordance with the disclosed architecture;

FIG. 5 illustrates an enhanced perspective view of a second end of one potential embodiment of a charging harness mounting device of the present invention with a channel in accordance with the disclosed architecture;

FIG. 6 illustrates a rear view of a second end of one potential embodiment of a charging harness mounting device of the present invention with a channel in accordance with the disclosed architecture;

FIG. 7 illustrates a perspective view of one potential embodiment of a charging harness mounting device of the present invention in accordance with the disclosed architecture;

FIG. 8 illustrates a perspective view of one potential embodiment of a charging harness mounting device of the present invention in accordance with the disclosed architecture;

FIG. 9 illustrates a flowchart of a method of using one potential embodiment of a charging harness mounting device of the present invention in accordance with the disclosed architecture;

FIG. 10 illustrates a flowchart of a method of using one potential embodiment of a charging harness mounting device of the present invention in accordance with the disclosed architecture; and

FIG. 11 illustrates a perspective view of one potential embodiment of a charging harness mounting device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for securing a charging harness. There also exists a long-felt need in the art for a charging harness mounting device. More specifically, there exists a long-felt need in the art for a charging harness mounting device that allows a charging harness to be secured to the frame of an ATV, dirt bike, UTV, or other vehicle.

The present invention, in one exemplary embodiment, is comprised of a charging harness mounting device. The device is designed to receive at least one charging harness, wherein the device secures the harness to at least one frame 16 (or other portion) of a vehicle such as, but not limited to, a motorcycle, a dirt bike, an ATV, a UTV, etc.

The device is comprised of a body that preferably forms an angle between 0 and 180 degrees and is comprised of a first end comprised of at least one (but preferably two) forks. The body is comprised of at least one opening between the forks such that the forks can be placed around either side of a flat portion of the frame of a vehicle. Then, at least one fastener can be placed through the forks and into the frame to secure the device to the frame. This allows the device to remain secured to the frame during use.

In one embodiment, the first end is comprised of at least one clamp that opens/closes relative to the body around at least one hinge. In this manner, at least one opening of the clamp can be secured around at least one frame of a vehicle the device is being used on. To secure the clamp around the frame, the clamp may be comprised of at least one locking mechanism of any type known in the art that inhibits movement of the clamp.

The second end of the body is comprised of at least one channel configured to receive the body of at least one charging harness. This allows the harness to be secured within the body such that the device prevents movement of the harness. In one embodiment, the body is comprised of at least one set screw opening. The opening may be threaded or non-threaded and allows at least one set screw (which may be threaded) to be inserted through the body to secure the charging harness in the body.

The device is also comprised of a first method of using the device. First, a device is provided comprised of a body with a first end comprised of at least two forks, and a channel. Then, the forks can be placed on a surface of a vehicle such that a removable fastener may be loosened/removed and positioned in an opening between the forks and fastened such that the body is secured to the vehicle's surface. Then, at least one charging harness can be placed into the channel of the body such that the harness is secured in a desired position.

The device is also comprised of a second method of using the device. First, a device is provided comprised of a body with a first end comprised of at least one clamp, and a channel. Then, the clamp can be opened and placed around a frame member of a vehicle such that the frame is positioned within the opening of the clamp. Next, the clamp can be closed around the frame and secured in a locked position via at least one locking mechanism. Then, at least one charging harness can be placed into the channel of the body such that the harness is secured in a desired position.

Accordingly, the charging harness mounting device of the present invention is particularly advantageous as it provides a device for securing a charging harness. More specifically, the device that allows a charging harness to be secured to the frame of an ATV, dirt bike, UTV, or other vehicle. In this manner, the harness and/or frame cannot be damaged and can be easily accessed in a constant location when needed. In this manner, the charging harness mounting device overcomes the limitations of existing charging harnesses known in the art.

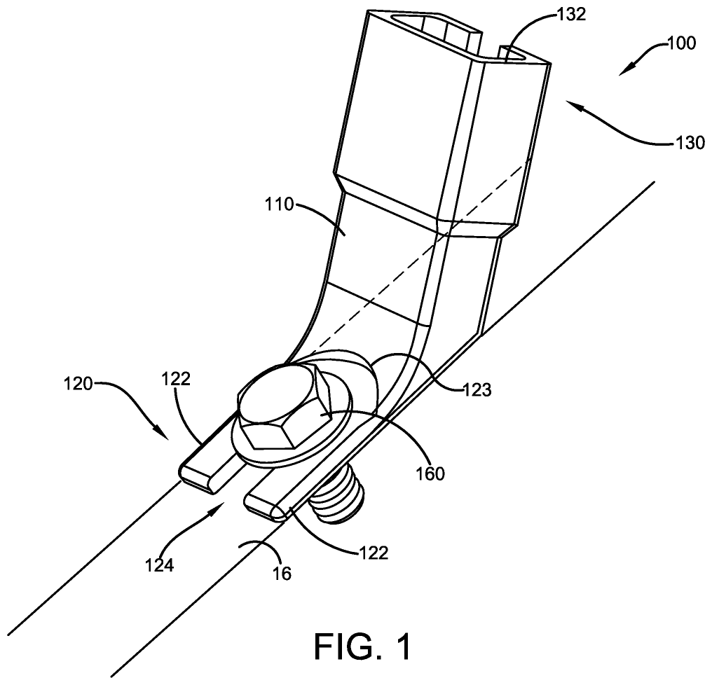

Referring initially to the drawings, FIG. 1 illustrates a perspective view of one potential embodiment of a charging harness mounting device 100 of the present invention with a fastener 160 placed between the forks 122 in accordance with the disclosed architecture. The device 100 is designed to receive at least one charging harness 10, wherein the device 100 secures the harness 10 to at least one frame 16 (or other portion) of a vehicle such as, but not limited to, a motorcycle, a dirt bike, an ATV, a UTV, etc.

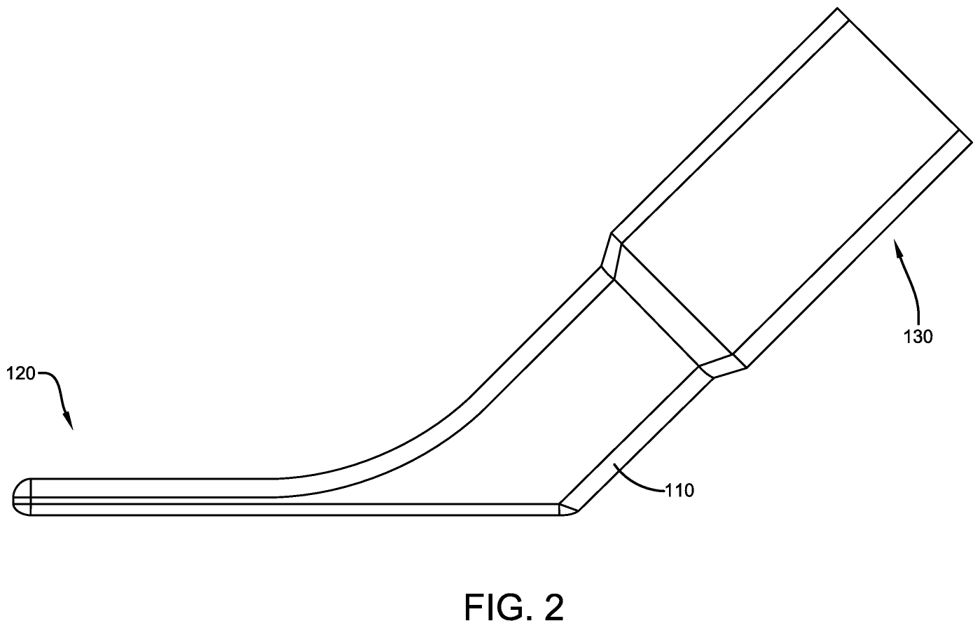

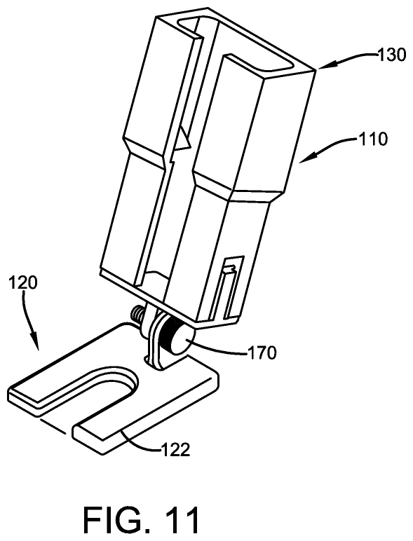

The device 100 is comprised of a body 110 that is preferably made from a plastic or metal material. The body 110 preferably forms an angle between 0 and 180 degrees, as seen in FIG. 2. This angle may be adjustable via a two-piece body construction, as seen in FIG. 11, wherein the forks 122 attach to the body 110 via at least one rotating attachment point 170 such as but not limited to a threaded fastener. The body 110 is comprised of a first end 120. In one embodiment, the first end 120 is comprised of at least one (but preferably two) forks 122. The body 110 is comprised of at least one opening 124 between the forks 122 such that the forks 122 can be placed around either side of a flat portion of a frame 16 of a vehicle, wherein at least one fastener 160, can be placed through the forks 122 and into the frame 16 to secure the device 100 to the frame 16. This allows the device 100 to remain secured to the frame 16 during use. In this embodiment, the forks 122 may have a raised edge 123 to facilitate placement of a fastener 160 such as, but not limited to, a screw, a bolt, a washer, or any fastener combination.

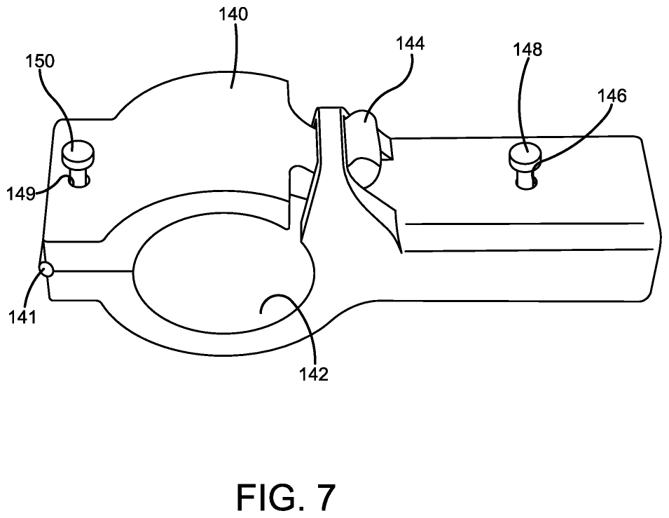

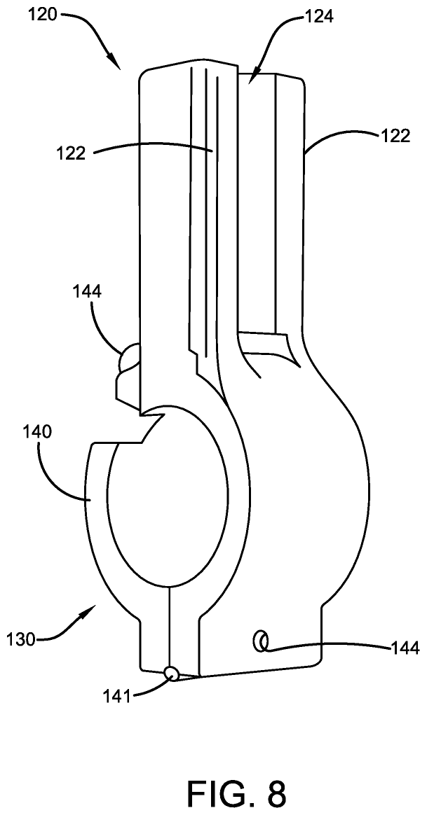

In one embodiment, the first end 120 is comprised of at least one clamp 140, as seen in FIG. 7 and FIG. 8. The clamp 140 can open/close relative to the body 110 around at least one hinge 141 (and/or parting line). In this manner, at least one opening 142 of the clamp 140 can be secured around at least one frame 16 of a vehicle the device 100 is being used on. To secure the clamp 140 around the frame 16, the clamp 140 may be comprised of at least one locking mechanism 144 of any type known in the art that inhibits movement of the clamp 140.

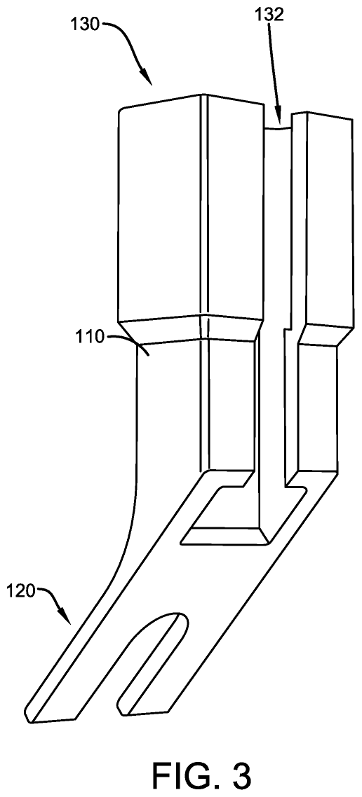

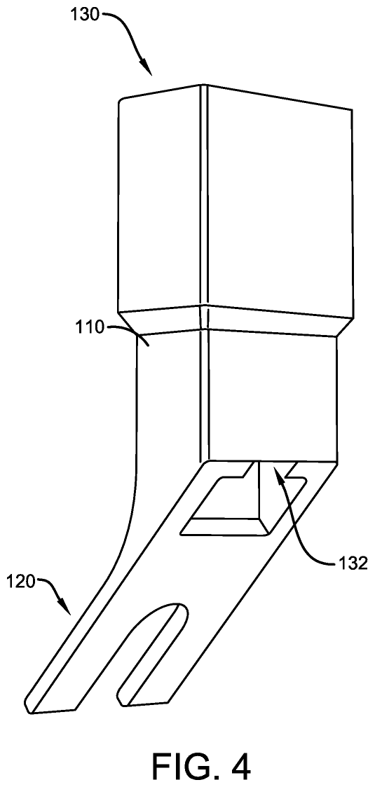

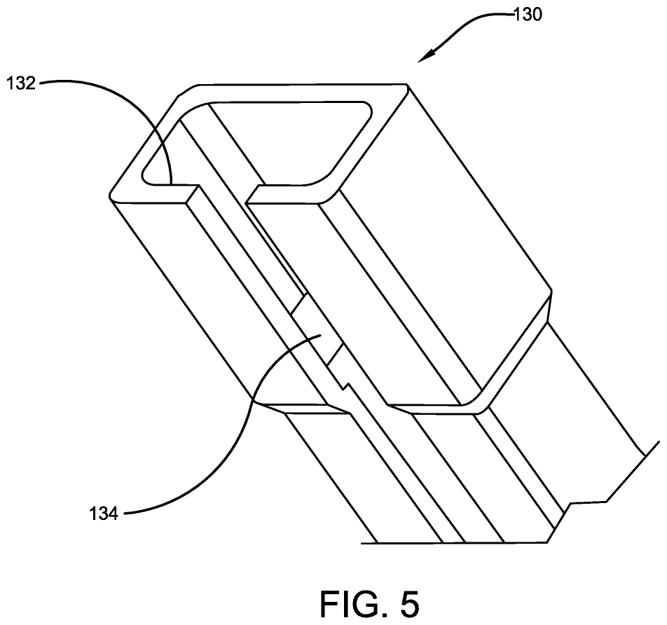

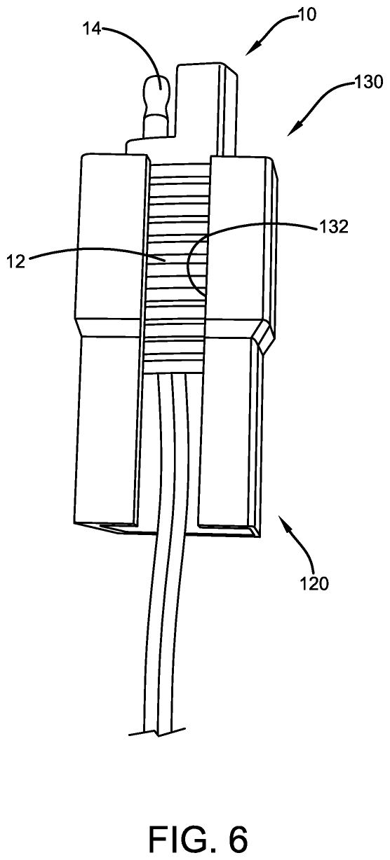

The second end 130 of the body 110 is comprised of at least one channel 132 in one embodiment, as seen in FIG. 3. The channel 132 is configured to receive the body 12 of at least one charging harness 10. This allows the harness 10 to be secured within the body 110 such that the device 100 prevents movement of the harness 10. More specifically, the channel 132 may begin at any portion of the body 110 but terminates at the second end 130 of the body 110 such that the charging port 14 of the charging harness 10 is exposed and accessible. In another embodiment, the channel 132 is instead in the form of an opening that extends through the body 110, as seen in FIG. 4. In one embodiment, the channel 132 is comprised of an internal ledge 134, as seen in FIG. 5. The ledge 134 keeps a charging harness 10 at a desired height and constant position within the body 110, as seen in FIG. 6.

In one embodiment, the body 110 is comprised of at least one set screw opening 146. The opening 146 may be threaded or non-threaded and allows at least one set screw 148 (which may be threaded) to be inserted through the body 110 to secure the charging harness 10 in the body 110. In another embodiment, the body 110 may also be comprised of at least one opening 149 that receives at least one fastener 150 that allows the body 110 to be secured to the frame 16. The opening 149 may be threaded/non-threaded, wherein the fastener 150 is preferably, but not limited to, a screw, a bolt, a zip tie, etc.

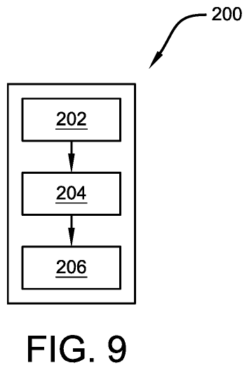

The device 100 is also comprised of a first method of using 200 the device 100, as seen in FIG. 9. First, a device 100 is provided comprised of a body 110 with a first end 120 comprised of at least two forks 122, and a channel 132 [Step 202]. Then, the forks 122 can be placed on a surface of a vehicle such as, but not limited to, a vehicle frame 16 such that a removable fastener 160 may be loosened/removed and positioned in an opening 124 between the forks and fastened to the body 110 and into the frame 16 such that the body 110 is secured to the frame 16 [Step 204]. Then, at least one charging harness 10 can be placed into the channel 132 of the body 110 such that the harness 10 is secured in a desired position [Step 206].

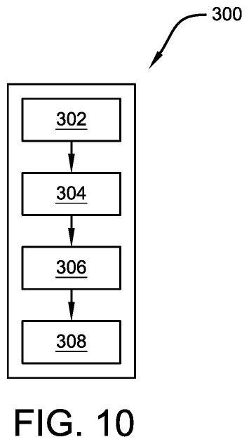

The device 100 is also comprised of a second method of using 300 the device 100, as seen in FIG. 10. First, a device 100 is provided comprised of a body 110 with a first end 120 comprised of at least one clamp 140, and a channel 132 [Step 302]. Then, the clamp 140 can be opened and placed around a frame 16 member of a vehicle such that the frame 16 is positioned within the opening 142 of the clamp 140 [Step 304]. Next, the clamp 140 can be closed around the frame 16 and secured in a locked position via at least one locking mechanism 144 [Step 306]. Then, at least one charging harness 10 can be placed into the channel 132 of the body 110 such that the harness 10 is secured in a desired position [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “charging harness mounting device” and “device” are interchangeable and refer to the charging harness mounting device 100 of the present invention.

Notwithstanding the foregoing, the charging harness mounting device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the charging harness mounting device 100 as shown in the FIGS. are for illustrative purposes only, and that many other sizes and shapes of the charging harness mounting device 100 are well within the scope of the present disclosure. Although the dimensions of the charging harness mounting device 100 are important design parameters for user convenience, the charging harness mounting device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A charging harness mounting device comprising:
a body having a first end and a second end:
a first fork positioned on the first end;
a second fork positioned on the second end; and
an opening positioned on the second end.

2. The charging harness mounting device of claim 1, wherein the first end is comprised of a raised edge.

3. The charging harness mounting device of claim 1, wherein the opening is comprised of a channel.

4. The charging harness mounting device of claim 3, wherein the channel is comprised of an internal ledge.

5. The charging harness mounting device of claim 1, wherein the body forms an angle between 0 and 180 degrees.

6. The charging harness mounting device of claim 1 further comprised of a fastener.

7. A charging harness mounting device comprising:
a body;
a clamp;
an opening;
a locking mechanism;
a set screw opening; and
an attachment opening.

8. The charging harness mounting device of claim 7 further comprised of a set screw.

9. The charging harness mounting device of claim 7 further comprised of a hinge.

10. The charging harness mounting device of claim 7, wherein the clamp attaches to the body via the hinge.

11. The charging harness mounting device of claim 7 further comprised of a first fork.

12. The charging harness mounting device of claim 7 further comprised of a second fork.

13. A method of using a charging harness mounting device, the method comprising the following steps:
providing a charging harness mounting device comprised of a body comprised of a first end comprised of a first fork and a second fork, and a channel;
placing the first fork and the second fork around a vehicle frame;
positioning a fastener between the forks and into the vehicle frame; and
placing a charging harness into the channel.

14. The method of using a charging harness mounting device of claim 13, wherein the channel is positioned at a second end of the body.

15. The method of using a charging harness mounting device of claim 13, wherein the vehicle is comprised of an ATV, a dirt bike, or a UTV.

16. The method of using a charging harness mounting device of claim 13, wherein the channel is comprised of an internal ledge.

17. The method of using a charging harness mounting device of claim 13, wherein the body forms an angle between 0 and 180 degrees.

18. The method of using a charging harness mounting device of claim 13, wherein the first end is comprised of a raised edge.

19. The method of using a charging harness mounting device of claim 13, wherein the body is comprised of a clamp.

20. The method of using a charging harness mounting device of claim 13, wherein the body is comprised of a set screw opening and a set screw.
